(19) United States
(12) Patent Application Publication
(10) Pub. No.: US 2007/0165392 A1
(43) Pub. Date: Jul. 19, 2007

(54) Light emitting diode structure

(75) Inventors: Tsung-Ting Sun, Chung-Ho City (TW); Hung-Ta Laio, Chung-Ho City (TW); Hung-Hsun Chou, Chung-Ho City (TW); Tz-Shiuan Yan, Chung-Ho City (TW)

Correspondence Address: HDSL, 4331 STEVENS BATTLE LANE, FAIRFAX, VA, 22033, US

(73) Assignee: Edison Opto Corporation

(21) Appl. No.: 11/331,106

(22) Filed: Jan. 13, 2006

(51) Int. Cl. H02B 1/01

(52) U.S. Cl. 361/831; 361/829

(57) ABSTRACT

A light emitting diode structure using a heat conducting medium as a grounding circuit includes a heat dissipating body, a support frame, and a base, wherein the upper half of the heat dissipating body has a circular heat dissipating column having a plane for preinstalling a light emitting diode chip, and the lower half of the heat dissipating body has a circular contact disc, and both left and right ends of the support frame separately include a plurality of pins, and a pin is connected to a circular contact end for fixing the heat dissipating column of the heat dissipating body, and then both are buried inside the base, and the bottom surface of the heat dissipating body contact disc is protruded from the bottom of the base, and the plurality of pins of the support frame is extended outward from both left and right sides of the base.

### BACKGROUND OF THE INVENTION

1. Field of the Invention

The present invention relates to a light emitting diode, and more particularly to a base structure used for resisting static electricity or reverse current of the light emitting diode.

2. Description of Prior Art

A light emitting diode is a solid state semiconductor device that combines two carriers produced by passing a current through the diode to release energies in a light form. The light emitting diode has the advantages of compact size, fast response, and pollution-free feature, so that the light emitting diodes are used extensively in many industries. Although the light emitting diode encountered the bottlenecks of having insufficient brightness and a low luminous efficiency at its early development stage, later developed high power light emitting diodes overcome the issue of insufficient brightness. As a result, the light emitting diode gradually enters into the highly efficiency illumination area and has a tendency increasingly replacing traditional tungsten lamps, and the light emitting diode is a product having a high potential replacing traditional lamps.

As the light emitting diode manufacturing technology is improved and new materials are developed constantly, high power light emitting diodes are developed, the energy efficiency is improved greatly, and the current passing unit area becomes larger, so that the operating heat produced by a chip becomes increasingly larger, and the surrounding of the chip becomes the best heat dissipating area of the operating heat. However, resin compounds having a high heat resistance are generally used for packaging light emitting diodes, and thus light emitting diodes have poor heat conductivity. If resin compounds wrap the whole chip and electrode circuit, heat will not be able to be dissipated successfully. As a result, an operating environment with a practically constant temperature is created, and the light emitting diode generally does not come with a structure having a heat dissipating function, so that the operating heat will be conducted and dissipated from the circuit to the outside directly by using the heat conductivity of the electrode circuit, but the electrode circuit will produce a larger thermal resistance and weaken the luminous efficiency of the light emitting diode.

In view of the shortcomings of the foregoing structure, a light emitting diode base structure as disclosed in U.S. Pat. No. 6,274,924 and shown in FIG. 1 adopts a base 10 as its main body, and the base 10 includes a plurality of electrode pins 101 therein, and the pins 101 are extended out from the base 10, and the base 10 includes a heat dissipating base 11 thereunder, and the heat dissipating base 11 includes a reflecting groove 111 for containing a light emitting diode chip 12. The chip 12 is in contact with a heat sink 13, and the chip 12 is surrounded by a plastic ring 102 inside the base 10, and an electric conductive wire is connected to the pin 101, so that when the light emitting diode is operating, the operating heat produced by the chip 12 will be conducted from the heat sink 13 under the chip 12 of the device and dissipated from the heat dissipating base 11 to the outside to complete the heat dissipation. In the meantime, the plastic ring 102 isolates the thermal conducting path with the electrode circuit to prevent the operating heat produced by the chip 12 using the electrode circuit as a thermal conducting path, and thus producing a larger thermal resistance and making the light emitting diode chip 12 unable to operate at a normal operating temperature.

The structure of the foregoing light emitting diode base 10 solves the heat dissipating problem, but the circuit constitutes an isolated state by the plastic ring 102 and the heat dissipating base 11, and the electrode circuit generally does not come with a grounding circuit. Therefore, if the light emitting diode is installed in an electronic component, and an external static electricity or a reverse current enters into the diode, the static electricity or reverse current will pass through the electrode circuit directly to produce a short circuit to the light emitting diode chip 12, and seriously damage the life of the light emitting diode. In some prior arts, a Zener diode is added to the electrode circuit, such that if the reverse current enters the diode, the reverse current will pass through the Zener diode first, then the Zener diode will be in the state of an open circuit, or if the reverse current is too large, then the Zener diode will be short circuited. Although such arrangement can timely protect the light emitting diode chip, it cannot protect light emitting diode chip for the next time when the Zener diode is short circuited and the static electricity or reverse current occurs again. Furthermore, adding the Zener diode increases the cost, but it still cannot fully protect the light emitting diode chip from being damaged by the static electricity or reverse current, and all of the above are the drawbacks of such light emitting diode base structure.

### SUMMARY OF THE INVENTION

The present invention is to overcome the shortcomings of the prior art by providing an improved light emitting diode structure that adopts a heat conducting medium as a grounding circuit and a support frame acting as an electrode circuit is in contact with a heat dissipating body acting as a heat conducting medium, such that an electrically conductive heat dissipating body becomes a grounding circuit for preventing any damage caused by a short circuit of the light emitting diode chip by using the electrode circuit, when static electricity or reverse current enters into the light emitting diode.

The present invention provides an improved light emitting diode structure comprising a heat dissipating body, a support frame, and a base, wherein the heat dissipating body has a heat dissipating column and a contact disc, and the support frame has a plurality of pins, and one of the pins is connected to a circular contact end for fixing the heat dissipating column of the heat dissipating body, and then both are buried into the interior of the base, and one side of the contact disc of the heat dissipating body is protruded from the bottom of the base, and the pins of the support frame are extended outwardly towards the base.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded view of a prior art;

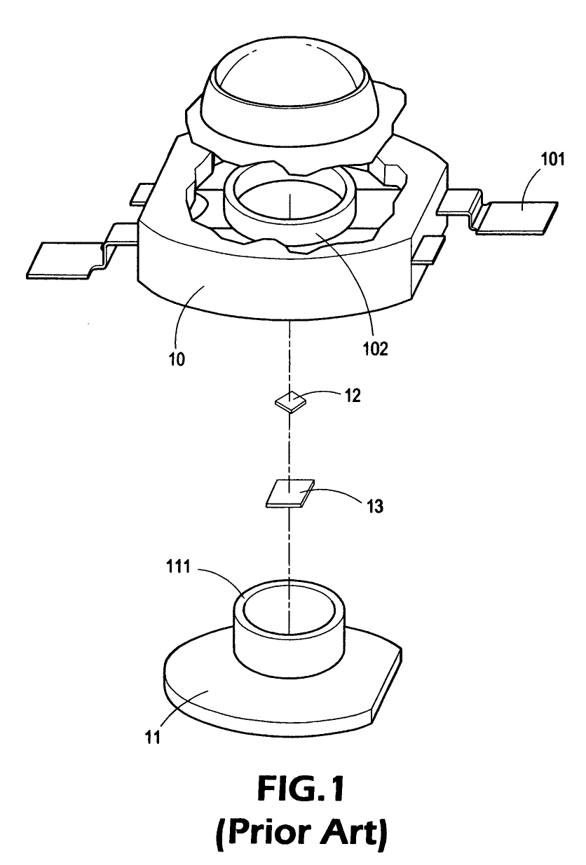

FIG. 2 is an exploded view of the present invention;

FIG. 3 is a perspective view of a structure of the present invention;

FIG. 4 is a side view of the bottom of a base of the present invention;

FIG. 5 is a front view of the present invention; and

FIG. 6 is a perspective view of a heat dissipating body and a support frame according to a preferred embodiment of the present invention.

### DETAILED DESCRIPTION OF THE INVENTION

The technical characteristics, features and advantages of the present invention will become apparent in the following detailed description of the preferred embodiments with reference to the accompanying drawings.

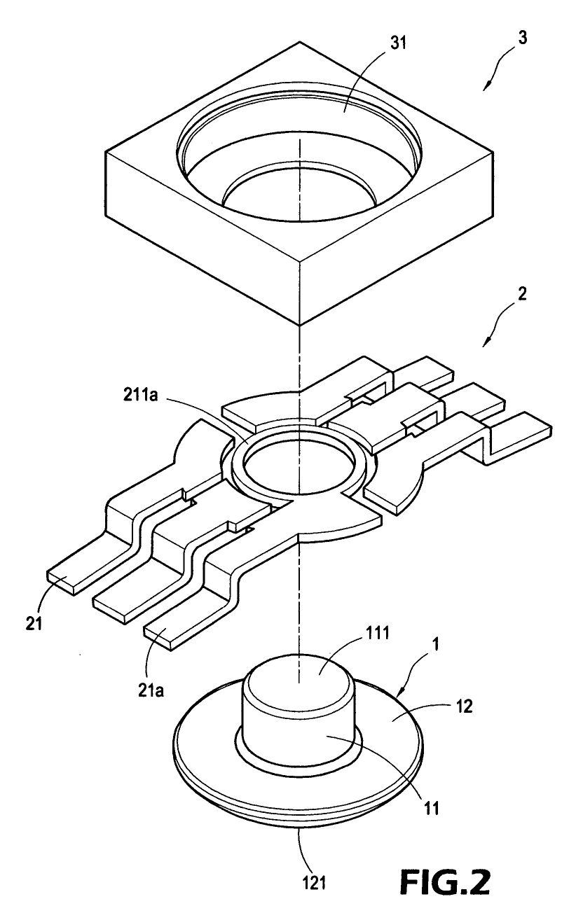

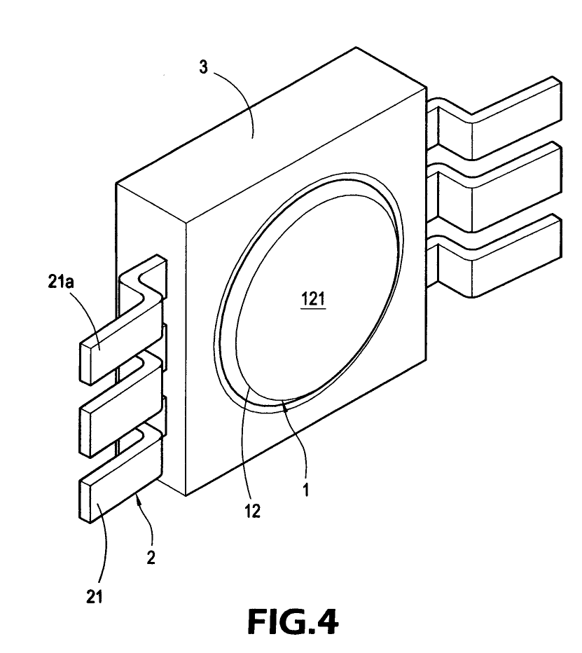

Referring to FIG. 2 for the exploded view of the present invention, the invention comprises a heat dissipating body 1, a support frame 2, and a base 3, wherein the heat dissipating body 1 and the support frame 2 are buried into the interior of the base 3, and the heat dissipating body 1 is made of a good electrically and thermally conductive metal such as copper, and the upper half of the heat dissipating body 1 has a circular heat dissipating column 11, and the heat dissipating column 11 has a plane 111 for preinstalling a light emitting diode chip (not shown in the figure), and the lower half of the heat dissipating body 1 has a circular contact disc 12, and the contact disc 12 has a circular contact surface 121 (as shown in FIG. 4). If the heat dissipating body 1 is buried into the interior of the base 3, then the contact surface 121 will be protruded slightly from the bottom surface of the base 3, such that the light emitting diode chip can conduct the operating heat directly or indirectly from the plane 111 to the contact surface 121 and dissipate the heat to the outside.

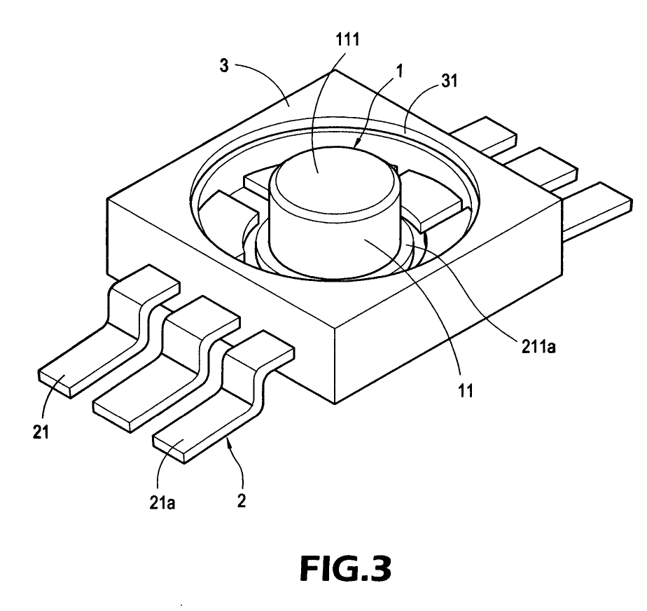

Further, the support frame 2 is made of a good electrically conductive metal such as aluminum and produced by an etching method and a stamping method. The left and right ends of the support frame 2 include a plurality of pins 21 used as an electric conducting end of the electrode circuit. In the figure, three pins are disposed on each end of the support frame 2, and the plurality of pins 21 is substantially in a curved shape and selected as an electrode connecting end according to the installing configuration. One of the pins 21a has a contact end 211a, and the contact end 211a in this preferred embodiment is substantially in an annular shape for fixing the heat dissipating column 11 of the heat dissipating body 1. After the support frame 2 and the heat dissipating body 1 are fixed, both are buried into the interior of the base 3, and the base 3 is a rectangular casing. After the support frame 2 and the heat dissipating body 1 are fixed, a formation is made by using an insert molding injection method to cover the connecting position of the support frame 2 and the heat dissipating body 1 as shown in FIG. 3. The pins 21 on both left and right ends of the support frame 2 are exposed from the base 3. After the connecting position of the base 1 with the support frame 2 and the heat dissipating body 1 is covered, then a sunken area 31 is formed around the position of the preinstalled light emitting diode chip for containing a packaging material for packaging the light emitting diode chip.

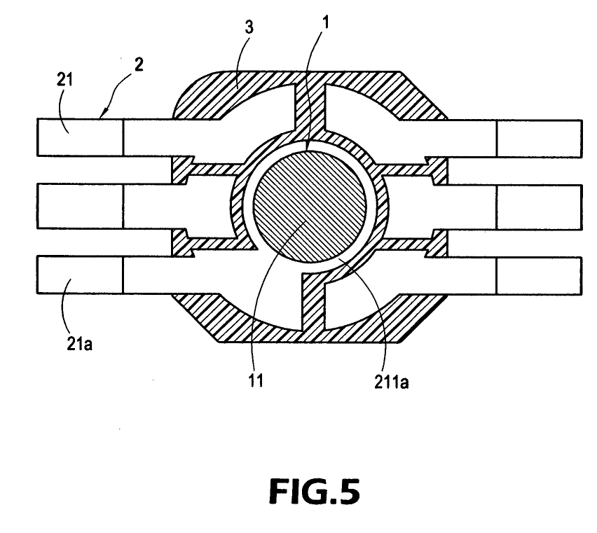

Referring to FIG. 5 for the front view of the present invention, the packaging process of the light emitting diode base 3 is completed and the light emitting diode is operated to emit lights, wherein the operating heat produced by the chip is conducted fro the heat dissipating column 11 at the bottom of the chip to the contact disc 12 protruded from the bottom of the base 3 and dissipated to the outside. In the meantime, the support frame 2 acting as an electrode uses the contact end 22 to contact with the heat dissipating column 11 of the heat dissipating body 1 directly, and the chip uses a wire conducting wire (not shown in the figure) to connect another pin 21 to form an electrode circuit, such that if the light emitting diode is installed in an electronic device and a static electricity or a reverse current occurs and enters into the light emitting diode from the electrode circuit comprised of the support frame 2 and the conducting wire, then the static electricity or reverse current will be transmitted along the heat dissipating column 11 attached on the light emitting diode chip and then from the contact surface 121 of the heat dissipating body 1 to the outside as shown in FIG. 5, such that the electrically conductive heat dissipating column 11 substantially forms a grounding circuit to protect the light emitting diode chip from being short circuited by the static electricity or the reverse current.

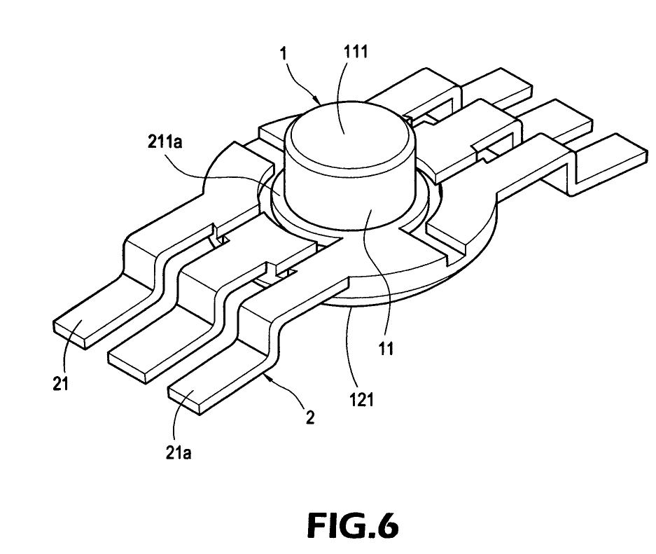

Referring to FIG. 6 for the heat dissipating body according to another preferred embodiment of the present invention, the heat dissipating body 1 and the support frame 2 are manufactured and fixed integrally, so that the heat dissipating column 11 is connected directly to a pin 21 of the support frame 2 and then the integrally formed structure of the heat dissipating body 1 and the support frame 2 is covered by an insert molding injection method.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A light emitting diode structure, comprising:
a heat dissipating body, having a heat dissipating column and a contact disc, and the heat dissipating column and the contact disc being coupled with each other;
a support frame, having a plurality of pins, and one of the pins having a contact end for fixing the heat dissipating column of the heat dissipating body;
a base, for wrapping the heat dissipating body and the support frame.

2. The light emitting diode structure of claim 1, wherein the heat dissipating body is made of an electrically and thermally conductive material.

3. The light emitting diode structure of claim 2, wherein the heat dissipating body is made of copper.

4. The light emitting diode structure of claim 1, wherein the contact disc further includes a contact surface.

5. The light emitting diode structure of claim 1, wherein the contact surface is protruded out from the bottom of the base.

6. The light emitting diode structure of claim 1, wherein the support frame is produced by an etching method or a stamping method.

7. The light emitting diode structure of claim 1, wherein the support frame is made of an electrically conductive material.

8. The light emitting diode structure of claim 1, wherein the support frame is made of aluminum.

9. The light emitting diode structure of claim 1, wherein one of the pins of the support frame further includes a contact end.

10. The light emitting diode structure of claim 9, wherein the contact end is in an annular shape.

11. The light emitting diode structure of claim 1, wherein the heat dissipating body and the support frame are formed integrally.

12. The light emitting diode structure of claim 1, wherein the base is made by an insert molding injection method.
